(19) United States
(12) Patent Application Publication
(10) Pub. No.: US 2008/0101302 A1
(43) Pub. Date: May 1, 2008

(54) METHOD AND SYSTEM FOR MANAGING COMMUNICATION SESSIONS IN A PLURALITY OF WIRELESS COMMUNICATION NETWORKS

(75) Inventors: Michael D. Kotzin, Buffalo Grove, IL (US); Gerald J. Gutowski, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,664

(22) Filed: Oct. 31, 2006

(51) Int. Cl. H04B 7/216

(52) U.S. Cl. 370/335

(57) ABSTRACT

A method and system for managing communication sessions in a plurality of wireless communication networks is provided. The plurality of wireless communication networks includes one or more home communication networks and one or more guest communication networks. The method at a communication device includes predicting (502) a coverage gap in a home communication network. The coverage gap is within a coverage region of the home communication network. Further, the method includes temporarily utilizing (504) at least one communication resource of a guest communication network when the communication device enters the coverage gap and when the at least one communication resource of the guest communication network is substantially available. The at least one communication resource enables communication at the communication device. The utilization of the at least one communication resource of the guest communication network is controlled by at least one of the home communication network and an overlay network.

The present invention generally relates to wireless communication networks, and more particularly, to a method and system for managing communication sessions in a plurality of wireless communication networks.

### BACKGROUND OF THE INVENTION

Wireless communication through communication networks such as a Global System for Mobile communication (GSM) network, a Code Division Multiple Access (CDMA) network, and a Universal Mobile Telecommunications System (UMTS) has become increasingly popular. A communication network enables communication between communication devices and provides various services, such as a Short Message Service (SMS), a Multimedia Message Service (MMS), and a live news service, in a region through electromagnetic (EM) waves. These EM waves can be transmitted through network terminals such as Base Transceiver Stations (BTSs). However, the EM waves cannot provide strong signals beyond a limited area, based on transmission frequencies and other characteristics. As a result, a BTS can provide coverage or enable wireless communication in a limited area of a region. Therefore, several BTSs are required to provide coverage in the complete region. The coverage can however be disrupted or may be poor in certain areas due to interruption in the transmission of EM waves, caused by uneven terrain, tall buildings, frequency interference, and so forth. This might severely deteriorate the quality of communication and various services. In a worst-case scenario, this might render communication and many services such as a live news service completely non-functional.

There exist various techniques for providing complete coverage in a region. One of the existing techniques involves installing closely spaced BTSs to ensure stronger EM wave signals and to avoid disruption of the transmission of EM wave signals. In another technique, a larger amount of network traffic is served by utilizing an additional frequency spectrum. However, one or more of these techniques involve additional capital investment due to requirement of the additional BTSs and spectrum. Further, in most instances, the investment can be significantly high. Moreover, provision of the additional spectrum may be regulated by the government, making its availability limited.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary region that is covered by a home communication network in accordance with an embodiment of the present invention;

FIG. 2 illustrates an exemplary region that is covered by a guest communication network, in accordance with an embodiment of the present invention;

FIG. 3 illustrates a region that is covered by the home communication network and by the guest communication network in accordance with an embodiment of the present invention;

FIG. 4 illustrates a block diagram of a managing system in accordance with an embodiment of the present invention;

FIG. 5 is a flow diagram illustrating a method for managing communication sessions in a plurality of wireless communication networks in accordance with an embodiment of the present invention; and

FIG. 6 is a flow diagram illustrating a method for managing communication sessions in a plurality of wireless communication networks in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

Before describing in detail the particular method and system for managing communication sessions in a plurality of wireless communication networks, in accordance with various embodiments of the present invention, it should be observed that the present invention resides primarily in combinations of method steps related to managing communication sessions in a plurality of wireless communication networks. Accordingly, the apparatus components and method steps have been represented, where appropriate, by conventional symbols in the drawings, showing only those specific details that are pertinent for an understanding of the present invention, so as not to obscure the disclosure with details that will be readily apparent to those of ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

In an embodiment, a method for managing communication sessions in a plurality of wireless communication networks is provided. The plurality of wireless communication networks includes one or more home communication networks and one or more guest communication networks. The method includes predicting a coverage gap in a home communication network. The coverage gap is within a coverage region of the home communication network. Further, the method includes temporarily utilizing at least one communication resource of a guest communication network, when the communication device enters into the coverage gap and the at least one communication resource of the guest communication network is substantially available. The at least one communication resource enables communication at the communication device. The utilization of the at least one communication resource of the guest communication network is controlled by the home communication network and/or an overlay network.

In another embodiment, a method for managing communication sessions in a plurality of wireless communication networks is provided. The plurality of wireless communication networks includes one or more home communication networks and one or more guest communication networks. The method includes enabling temporary utilization of at least one communication resource of a guest communication network when a communication device enters into a coverage gap in a home communication network and the at least one communication resource of the guest communication network is substantially available. The at least one communication resource enables communication at the communication device. Further, the method includes temporarily controlling the utilization of the at least one communication resource of the guest communication network. The utilization is temporarily controlled by the home communication network and/or an overlay network.

In yet another embodiment, a system for managing communication sessions in a plurality of wireless communication networks is provided. The system includes an allocation module that is capable of enabling temporary utilization of at least one communication resource of a guest communication network. The temporary utilization is enabled when a communication device enters into a coverage gap in a home communication network and the at least one communication resource of the guest communication network is substantially available. The at least one communication resource enables communication at the communication device. Further, the system includes a control module that is capable of controlling the utilization of the at least one communication resource in the guest communication network. The utilization is controlled by the home communication network and/or an overlay network.

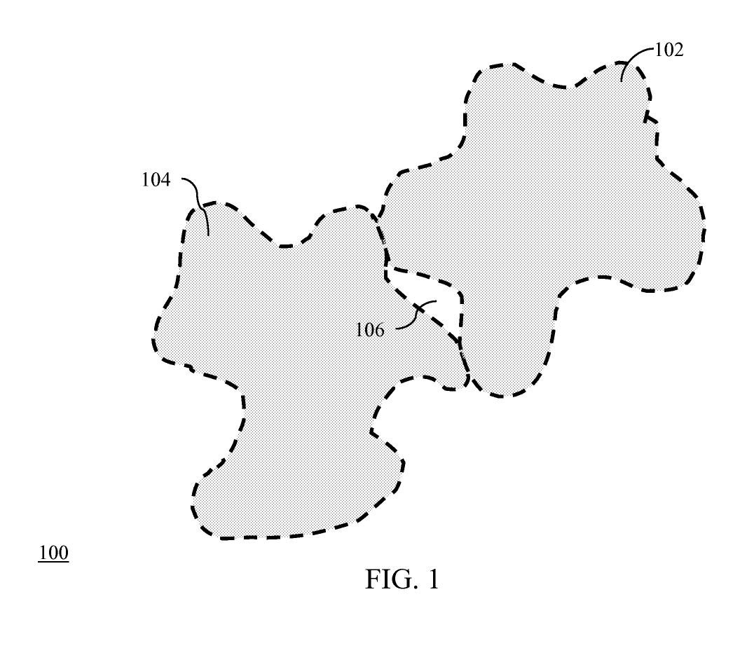

FIG. 1 illustrates an exemplary region 100 that is covered by a home communication network in accordance with an embodiment of the present invention. The areas 102 and 104 (shown as shaded areas) are covered by the home communication network. Examples of the home communication network include, but are not limited to, a Global System for Mobile Communication (GSM) network, a Code Division Multiple Access (CDMA) network, and a Universal Mobile Telecommunications System (UMTS) network. The home communication network enables communication devices to communicate in the areas 102 and 104 by usage of communication resources. Communication services in the areas 102 and 104 are provided by Base Transceiver Stations (BTSs), not shown in FIG. 1, located near the center of the respective areas 102 and 104. Examples of communication resources include, but are not limited to, communication signals, communication channels, communication bandwidth and associated services provided by the communication network.

Further, a quality of communication in an area can be defined by a Quality of Service (QoS) in the area. The QoS is a measure of various parameters, including signal strength, signal quality, Bit Error Rate (BER), fading, jitter, and delay in service. Certain areas in the region 100 may not be covered by the home communication network, which degrades the QoS in those areas. This can lead to a poor quality of communication, and in the worst case, this can disable the communication in those areas. This may be due to non-availability of the communication resources, the associated services and the content provided by the communication network in those areas. This could be due to irregularity of the coverage areas. Further, the QoS in certain areas can be below a threshold, hampering the quality of voice communication, disabling or dropping calls and services, and slowing down Internet speed in the areas. Such areas are referred to as coverage gaps, for example, a coverage gap 106. The threshold is a predefined level of QoS, corresponding to various parameters of the QoS, that are required to maintain a predefined quality of communication. Below this threshold of the QoS, the communication devices may not be able to communicate properly.

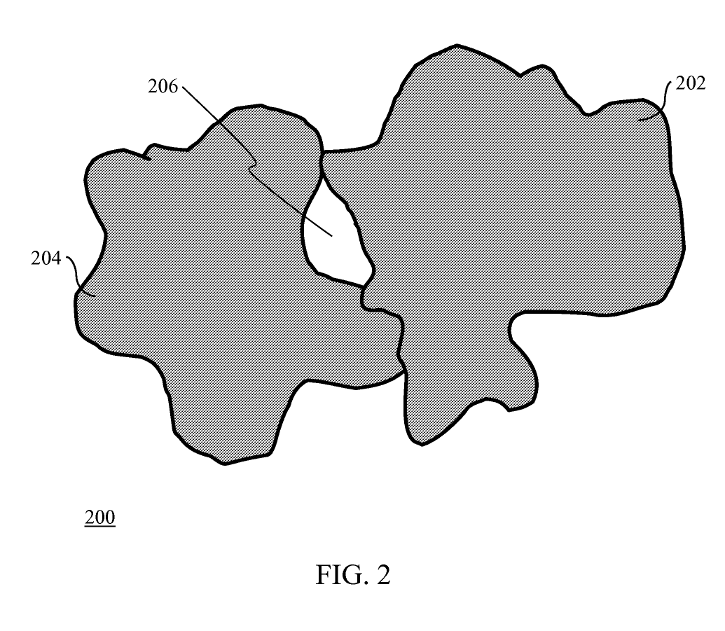

FIG. 2 illustrates an exemplary region 200 that is covered by a guest communication network in accordance with an embodiment of the present invention. The areas 202 and 204 (shown as shaded areas) of the region 200 are covered by the guest communication network. Examples of the guest communication network include, but are not limited to, a Global System for Mobile communication (GSM) network, a Code Division Multiple Access (CDMA) network and a Universal Mobile Telecommunications System (UMTS) network. For an embodiment, the guest communication network can be operated by a commercial entity different from a commercial entity operating the home communication network. The region 200 includes a coverage gap 206. Further details of the coverage gap 206 and the guest communication network are similar to that of the coverage gap 106 and the home communication network, respectively, as described in FIG. 1.

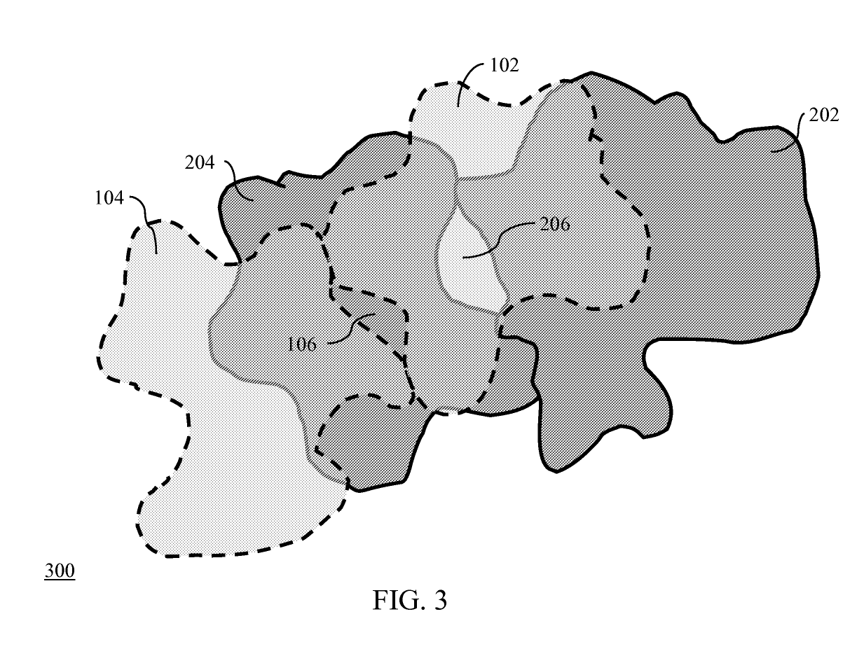

FIG. 3 illustrates an overlapping region 300 that is covered by the home communication network and the guest communication network in accordance with an embodiment of the present invention. For the purpose of this description, the region 300 is shown to be a combination of the regions 100 and 200. The coverage gap 106 in the home communication network is shown to be covered by the guest communication network. Similarly, the coverage gap 206 in the guest communication network is shown to be covered by the home communication network. As a result, the entire region 300 is covered either by the home communication network or by the guest communication network. In other words, communication resources of the guest communication network are substantially available in the coverage gap 106, enabling communication in the coverage gap 106. A communication device, such as a mobile phone, in the coverage gap 106 can utilize the communication resources and the services of the guest communication network to communicate with other communication devices, to facilitate the continuation of an existing service and to request for a new service that is not provided by the home communication network. Similarly, the communication resources of the home communication network are substantially available in the coverage gap 206, enabling communication in the coverage gap 206. A communication device in the coverage gap 206 can utilize the communication resources of the home communication network to communicate with other communication devices. For an embodiment, the home communication network and the guest communication network can utilize each other's communication resources to enable communication in their respective communication gaps. For example, a communication resource, such as a communication channel, of the guest communication network can be allocated to the home communication network in the coverage gap 106.

For an embodiment, the utilization of the communication resources of other communication networks can be managed by an overlay network, not shown in FIG. 3. The overlay network can be a third party network that can control and enable the usage of a portion of the communication resources of the guest communication network by the home communication network and vice versa. For example, consider a region that is covered by a first communication network and a second communication network. The first communication network has a coverage gap that is covered by the second communication network. In this example, a third party arbitrator can act as an overlay network. The third party arbitrator can allocate certain channels of the second communication network to the first communication network, as and when required. This will enable communication in the coverage gap as well.

Although it is described that the coverage gap 106 is completely covered by the guest communication network, it will be apparent to those ordinarily skilled in the art that a portion of the coverage gap 106 may remain uncovered when the invention is practiced. However, the uncovered portions of the coverage gap 106 may be significantly small, as compared to the size of the coverage gap 106. Further, it should be noted that though the invention is described for a home communication network and a guest communication network, it will be apparent to those ordinarily skilled in the art that the invention can be implemented for more than two communication networks as well.

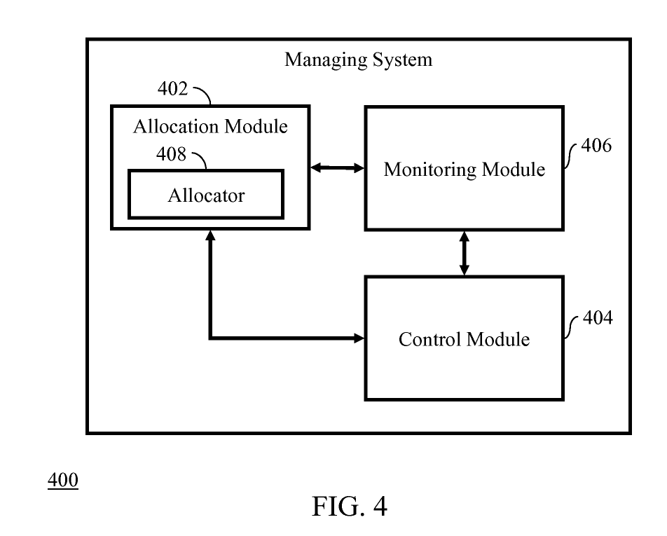

FIG. 4 illustrates a block diagram of a managing system 400 in accordance with an embodiment of the present invention. The managing system 400 includes an allocation module 402 and a control module 404. The allocation module 402 enables temporary utilization of at least one communication resource of the guest communication network when a communication device in the home communication network enters into the coverage gap 106 and the at least one communication resource of the guest communication network is substantially available. The at least one communication resource enables communication at the communication device in the coverage gap 106. The temporary utilization is enabled by allocation of the at least one communication resource of the guest communication network to the home communication network. For example, all the communication channels allocated to the home communication network may be either unavailable or unable to provide the required QoS to subscribers in the coverage gap 106. Therefore, a predefined number of channels of the guest communication network are allocated to the home communication network in coverage gap 106. For another example, if the data transmission rate in the coverage gap 106 is less than the threshold, Internet services may not be available to subscribers in the coverage gap 106. However, when communication is routed through the channels of the guest communication network that provides an adequate data transmission rate, the subscribers in the coverage gap 106 can use Internet services.

For an embodiment, the allocation module 402 can be located in the home communication network. For another embodiment, the allocation module 402 can be located in an overlay network. The overlay network can be a third party network or a third party arbitrator that can manage the utilization of the at least one communication resource of the guest communication network by the home communication network, and vice versa. The overlay network can determine the number of channels of the guest communication network to be allocated and the time of the allocation of the channels to the home communication network.

Further, the control module 404 controls the utilization of the at least one communication resource in the guest communication network. The utilization of the at least one communication resource is controlled by the home communication network. The control module 404 can be present in the home communication network. For example, the home communication network can determine which channel of the guest communication network will be allocated to a particular communication device. For another example, the control module 404 in the home communication network can determine the time to return the control of channels to the guest communication network.

For an embodiment, the home communication network controls the at least one communication resource of the guest communication network in a way the home communication network controls its own communication resources. For example, the control signaling and traffic flow in a communication channel of the guest communication network can be controlled by the home communication network. For another example, the service messages sent by a communication device through a communication channel of the guest communication network are received by the home communication network. For yet another example, the messages that a communication device sends for call control, measurement reports and services can be received by the home communication network.

For an embodiment, the managing system 400 also includes a monitoring module 406. The monitoring module 406 monitors the status of at least one communication resource. For example, the monitoring module 406 can monitor the strength of signals or the bandwidth of the home communication network in the coverage gap 106. The monitoring module 406 can also monitor the QoS that is available at the communication device. For example, the monitoring module 406 can monitor the rate of data transmission in the home communication network. Based on the available QoS, the monitoring module 406 determines whether or not a communication device is in the coverage gap 106. For example, the monitoring module 406 may monitor BER, jitter, latency or the security level. When it is determined that the QoS is below the threshold, the communication device is considered to be in the coverage gap 106.

The monitoring module 406 also monitors the at least one communication resource of the guest communication network in order to determine if the communication resource is substantially available in the coverage gap 106. For example, when a communication device is in the coverage gap 106, the at least one communication resource of the guest communication can be considered to be substantially available when the available QoS of the at least one communication resource of the guest communication network is above the threshold.

For an embodiment, the monitoring module 406 can be located in the home communication network. For another embodiment, the monitoring module 406 can be located in an overlay network, which can be a third party network. For yet another embodiment, the monitoring module 406 can be located in a communication device, continuously interacting with the home communication network.

Further, when it is determined that the communication device is in the coverage gap 106, the allocation module 402 enables temporary utilization of the at least one communication resource of the guest communication network. For an embodiment, an allocator 408, in the allocation module 402, allocates the at least one communication resource of the guest communication network to the communication device when the communication device enters the coverage gap 106. For example, when a communication frequency band that is allotted to the home communication network is unavailable, the communication frequencies of the guest communication network can be allocated to the home communication network.

For an embodiment, even when the communication device is using the at least one communication resource of the guest communication network, the monitoring module 406 keeps monitoring the available QoS of the home communication network. For an embodiment, when an adequate QoS, that is, a QoS more than the threshold, is available in the home communication network, the control module 404 disables the utilization of the at least one resource of the guest communication network. Further, the control module 404 enables the utilization of at least one communication resource of the home communication network by the communication device.

Moreover, the monitoring module 406 monitors a time interval for which the at least one communication resource of the guest communication network can be utilized by the communication device. This can be used for various purposes such as a billing record. For example, a cost for the usage of the guest communication network's resource can be charged to the home communication network in accordance with a previously established commercial agreement. In addition, the monitoring module 406 may establish session count indicators and session resource utilization metrics for service requests such as requests for information about an Internet Protocol Television channel, requests for Voice Over Internet Protocol (VOIP), and requests for information about the location through the Global Positioning System (GPS). The session count indicators and the session resource utilization metrics can be indicated by the communication device to gauge the guest network's resource utilization for adherence to the commercial agreements.

It should be noted that the elements of the managing system 400 can be located at various locations, such as a Base Transceiver Station (BTS), a Base Station Controller (BSC), a Packet Data Gateway (PDG), a GPRS (General Packet Radio Service) Routing Exchange (GRX), a Wireless Local Area Network (WLAN) (e.g., 802.11) switch, a gateway between a cellular network and an Internet Protocol (IP) network (e.g., a Gateway GPRS Support Node (GGSN)), a Serving GPRS Support Node (SGSN), and a mobility router in one or more of the home communication networks, the guest communication network, or an overlay network. Moreover, the functions of each element of the managing system 400 can be performed by one element or by a combination of one or more elements.

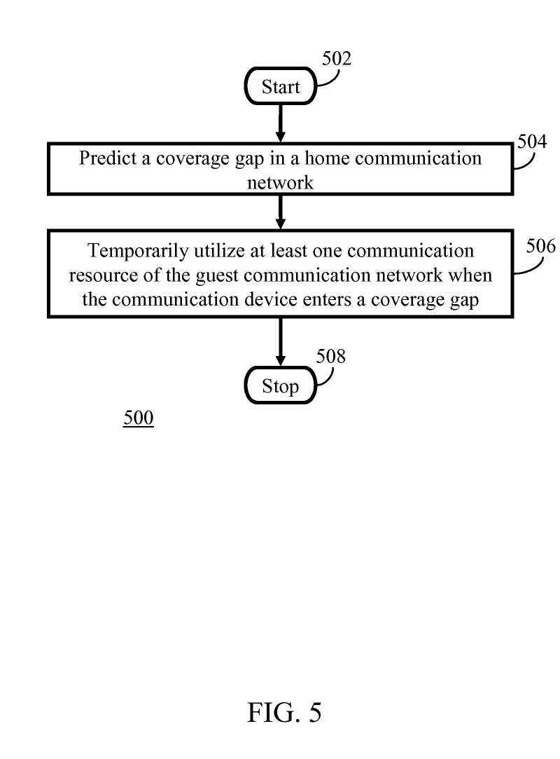

FIG. 5 is a flow diagram 500 illustrating a method for managing communication sessions in a plurality of wireless communication networks in accordance with an embodiment of the present invention. To describe the flow diagram 500, reference is made to FIGS. 1, 3, and 4, although it will be understood that the flow diagram 500 can be implemented with reference to any other suitable embodiment of the invention. In addition, the flow diagram 500 can contain a greater or fewer number of steps than shown in FIG. 5.

At step 502, the method for managing communication sessions in a plurality of wireless communication networks is initiated at a communication device. At step 504, the coverage gap 106 in the home communication network is predicted. For an embodiment, the event of the communication device entering the coverage gap 106 is predicted. For another embodiment, the event of declining coverage is predicted. For an embodiment, based on monitoring of at least one communication resource of the home communication network and at least one communication resource of the guest communication network, it is predicted whether the communication device is in the coverage gap 106. For an embodiment, the monitoring is done by the monitoring module 406. The at least one communication resource enables communication at the communication device. In another embodiment, the at least one communication resource of the guest communication network is monitored to determine whether the at least one communication resource of the guest communication network is substantially available in the coverage gap 106.

At step 506, the at least one communication resource of a guest communication network is temporary utilized, when the communication device enters the coverage gap 106 and the at least one communication resource of the guest communication network is substantially available. For an embodiment, temporary utilization of the at least one communication resource of the guest communication network is enabled by the home communication network. For another embodiment, the temporary utilization of the at least one communication resource of the guest communication network is enabled by the overlay network.

When the communication device moves out of the coverage gap 106, for example, when the at least one communication resource of the home communication network is substantially available, the communication device reutilizes the at least one communication resource of the home communication network. For an embodiment, the communication device intimates the home communication network to return control of the at least on communication resource of the guest communication network when the at least one communication resource of the home communication network is substantially available. For example, the control may be returned when the communication device moves out of the coverage gap 106. Thereafter, the method ends at step 508.

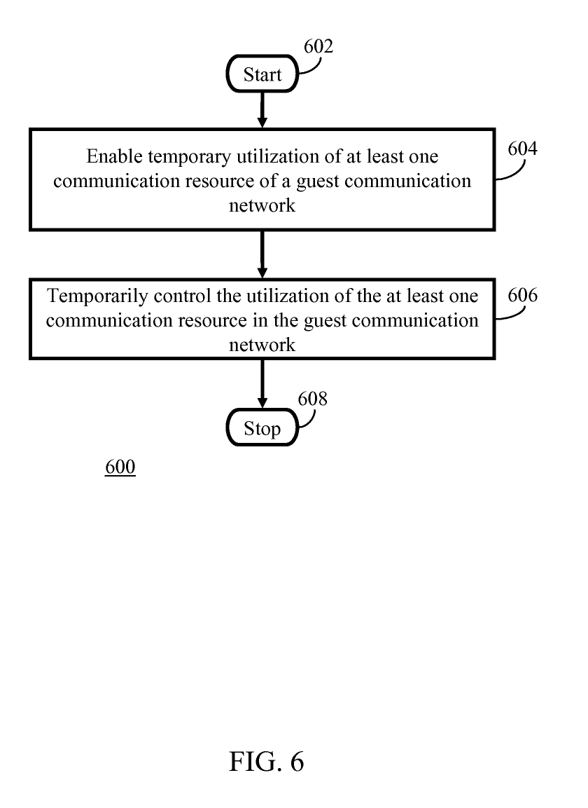

FIG. 6 is a flow diagram illustrating a method for managing communication sessions in a plurality of wireless communication networks in accordance with another embodiment of the present invention. To describe the flow diagram 600, reference is made to FIGS. 1, 3, and 4, although it is understood that the flow diagram 600 can be implemented with reference to any other suitable embodiment of the invention. In addition, the flow diagram 600 can contain a greater or fewer number of steps than shown in FIG. 6.

At step 602, the method for managing communication sessions in a plurality of wireless communication networks is initiated. At step 604, temporary utilization of the at least one communication resource of a guest communication network is enabled when the communication device enters the coverage gap 106 in the home communication network and the at least one communication resource of the guest communication resource is substantially available. For an embodiment, when the communication device enters the coverage gap 106, the at least one resource of the guest communication network is allocated to the home communication network. The at least one communication resource of the guest communication network is allocated to the home communication network to enable communication at the communication device.

For an embodiment, information pertaining to the at least one communication resource of the home communication network and the guest communication network is received from the communication device. For example, the communication device can provide information related to the signal strength or the quality of communication in the communication channel at which the communication device is communicating. The communication device can provide the information through measurement messages. The measurement messages can be provided while using the at least one communication resource of either of the home communication network and the guest communication network. These measurement messages can also include information about an availability and a utilization of the at least one communication resource of the home communication network and the guest communication network. This information can be used to determine whether the communication device is in the coverage gap 106. For another example, information pertaining to the rate of the downloading of web content can be used to determine whether a communication device is in the coverage gap 106. For example, when the downloading rate is below 100 kilobytes per second (kbps), the communication device can be considered to be in the coverage gap 106. When the communication device is in the coverage gap 106, the information is used to determine which communication resources, such as a communication channel, are available. For example, when it is determined that the communication device is in the coverage gap 106, information pertaining to various Internet enablement services of the guest communication network is used to determine which Internet enablement service is available to be allocated to the home communication network.

At step 606, utilization of the at least one communication resource is temporarily controlled. For an embodiment, the utilization is controlled by the home communication network. For example, traffic and connectivity-signals over the at least one communication resource of the guest communication network is controlled by the home communication network. For another embodiment, the utilization is controlled by the overlay network. For example, the home communication network and/or the overlay network can decide when to use the allocated bandwidth of the guest communication network and when to return the allocated bandwidth.

For an embodiment, when the communication device comes out of the coverage gap 106, for example, when the at least one communication resource of the home network is substantially available to provide quality communication, the utilization of the at least one communication resource of the home communication network is re-enabled. Thereafter, control of the at least one communication resource of the guest communication network is returned to the guest communication network. Thereafter, the method terminates at step 608.

As described above, various embodiments of the method and system for managing communication sessions in a plurality of wireless communication networks provide the following advantages. One advantage is the increased reliability of communication in the existing coverage gaps. A user of the communication device who is using the services of the home communication network can utilize the services of another communication network, for example, another home communication network or a guest network, when the communication device enters a coverage gap in the home communication network. Further, the invention advantageously provides a better mutual coverage region to the one or more home communication networks and the one or more guest communication networks. Moreover, the increased coverage provided by various embodiments of this invention is significantly inexpensive, as compared to the cost of increasing the coverage by augmenting the spectrum.

It will be appreciated that the method and system for managing communication sessions in a plurality of wireless communication networks described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to manage communication sessions in a plurality of wireless communication networks. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing communication sessions in a plurality of wireless communication networks, the plurality of wireless communication networks comprising one or more home communication networks and one or more guest communication networks, the method at a communication device comprising:
predicting a coverage gap in a home communication network, wherein the coverage gap is within a coverage region of the home communication network; and
temporarily utilizing at least one communication resource of a guest communication network when the communication device enters the coverage gap, wherein the at least one communication resource of the guest communication network is substantially available, wherein the at least one communication resource enables communication at the communication device, and wherein utilization of the at least one communication resource of the guest communication network is controlled by at least one of the home communication network and an overlay network.

2. The method as recited in claim 1, wherein quality of service in the coverage gap is less than a threshold, and wherein the service is selected from the group comprising Bit Error Rate (BER), jitter, latency, and a security level.

3. The method as recited in claim 1 further comprising monitoring the at least one communication resource of at least one of the home communication network and the guest communication network, wherein the at least one resource is monitored by at least one of the home communication network and the overlay network.

4. The method as recited in claim 1, wherein the at least one communication resource is selected form the group comprising communication signals, communication channels and communication bandwidth.

5. The method as recited in claim 1 further comprising indicating at the communication device that the at least one communication resource of the guest communication network is being utilized, wherein the communication device is indicated by at least one of the home communication network and the overlay network.

6. The method as recited in claim 1, wherein temporarily utilizing the at least one communication resource in the guest communication network comprises enabling the utilization by the overlay network.

7. The method as recited in claim 1 further comprising re-utilizing the at least one communication resource of the home communication network when the at least one communication resource of the home communication network is substantially available.

8. The method as recited in claim 7 further comprising intimating the home communication network to return control of the at least one communication resource of the guest communication network to the guest communication network when the utilization of the at least one resource of the guest communication network is controlled by the overlay network.

9. A method for managing communication sessions in a plurality of wireless communication networks, the plurality of wireless communication networks comprising one or more home communication networks and one or more guest communication networks, the method comprising:
enabling temporary utilization of at least one communication resource of a guest communication network when a communication device enters a coverage gap in a home communication network and the at least one communication resource of the guest communication network is substantially available, wherein the at least one communication resource enables communication at the communication device; and
temporarily controlling the utilization of the at least one communication resource in the guest communication network, the utilization being temporarily controlled by at least one of the home communication network and an overlay network.

10. The method as recited in claim 9, wherein quality of service in the coverage gap is less than a threshold, and wherein the service is selected from the group comprising Bit Error Rate (BER), jitter, latency, and a security level.

11. The method as recited in claim 9 further comprising receiving resource information from the communication device, the resource information being gathered by monitoring at least one communication resource of at least one of the home communication network and the guest communication network.

12. The method as recited in claim 9 further comprising monitoring a time interval for which the at least one communication resource of the guest communication network is utilized.

13. The method as recited in claim 9, wherein the temporary utilization of the at least one communication resource of a guest communication network is enabled by the overlay network.

14. The method as recited in claim 9 further comprising re-enabling the utilization of the at least one communication resource of the home communication network when the at least one communication resource of the home communication network is substantially available

15. The method as recited in claim 14 further comprising returning control of the at least one communication resource of the guest communication network to the guest communication network.

16. The method as recited in claim 9, wherein enabling the temporary utilization of the at least one communication resource of the guest communication network comprises allocating the at least one communication resource of the guest communication network to the home communication network.

17. A system for managing communication sessions in a plurality of wireless communication networks, the system comprising:
an allocation module capable of enabling temporary utilization of at least one communication resource of a guest communication network of the plurality of communication networks when a communication device enters a coverage gap in a home communication network of the plurality of communication networks and the at least one communication resource of the guest communication network is substantially available, wherein the at least one communication resource enables communication at a communication device; and
a control module capable of controlling utilization of the at least one communication resource in the guest communication network, the utilization being controlled by at least one of the home communication network and an overlay network.

18. The system as recited in claim 17 further comprising a monitoring module that monitors status of the at least one communication resource and a time interval for which the at least one communication resource of the guest communication network is utilized.

19. The system as recited in claim 17, wherein the allocation module comprises an allocator capable of allocating the at least one communication resource of the guest communication network to the home communication network.

20. The system as recited in claim 17, wherein the system is located at one of a Base Transceiver Station, a Base Station Controller, a Packet Data Gateway, a General Packet Radio Service Routing Exchange, a Wireless Local Area Network switch, a gateway between a cellular network and an Internet Protocol network, a General Packet Radio Service Support Node, and a mobility router.
